(19) United States
(12) Patent Application Publication
(10) Pub. No.: US 2010/0123020 A1
(43) Pub. Date: May 20, 2010

(54) PAINT SPRAY GUN WITH PAINT JET DEFLECTION

(75) Inventors: Alfred GOHRING, Salem (DE); Thomas Jeltsch, Friedrichshafen (DE)

Correspondence Address: BURR & BROWN, PO BOX 7068, SYRACUSE, NY, 13261-7068, US

(73) Assignee: J. Wagner GmbH, Markdorf (DE)

(21) Appl. No.: 12/620,653

(22) Filed: Nov. 18, 2009

(30) Foreign Application Priority Data
Nov. 19, 2008 (EP) 08 020 160.1

(51) Int. Cl. B05B 9/01

(52) U.S. Cl. 239/71; 239/302

(57) ABSTRACT

The paint spray gun according to the invention with paint jet deflection comprises a spray gun body with a paint reservoir, a paint dispensing device, an airflow gate with through flow orifices, an air cap with through flow orifices and a first through flow air director or air horn with a first air passage cross section and at least one second through flow air director or air horn with a second air passage cross section, the airflow gate being arranged in front of the air cap in the airflow direction in the region of the paint dispensing device. The invention is characterized in the present case in that the first air passage cross section is designed to be enlarged with respect to at least the second air passage cross section.

This application claims the benefit under 35 USC §119(a)-(d) of European Application No. 08 020 160.1 filed Nov. 19, 2008, the entirety of which is incorporated herein by reference.

### FIELD OF THE INVENTION

The invention relates to a paint spray gun with paint jet deflection.

### BACKGROUND OF THE INVENTION

Paint spray guns have many different applications in the trade sector. A large number of spray gun designs are known to the professional painter and in lacquering and to amateurs and for semi-professional application.

Appliances of what is known as the HVLP class constitute an advanced generic type of spray gun. HVLP technology makes use, in this context, of a high available air volume, along with a relatively low operating pressure (High Volume Low Pressure).

The prevailing principle of paint spray guns is always based fundamentally on the mechanism whereby a small defined paint quantity is dispensed out of a paint dispensing device, usually a needle valve, and has flowing around it in a radially symmetrical manner an air jet which entrains the paint and generates a fine paint mist, what is known as a spray. A spray or paint jet is likewise, as a rule, formed radially symmetrically, which is often felt to be a disadvantage in the coating of planar surfaces.

Paint spray guns are known from the prior art, for example from EP 1 880 771 A1, which, via a defined arrangement of an air cap in front of an airflow gate, make it possible to adjust the paint jet geometry in that airflows through additional air directors in the form of air horns on the air cap, the airflowing through being directed onto the paint jet by the air directors. The directed air thus impinging laterally onto the paint jet generates from the hitherto radially symmetrical paint jet a flat jet which for the treatment of surfaces makes it possible to have substantially more homogeneous color application and therefore to work more efficiently.

The disadvantage of paint spray guns of this type is that, especially at locations where access is difficult or on ceilings and floors, extreme holding positions, such as, for example, vertically upward or downward, have to be assumed in order to achieve a proper result.

DE 32 48 578 A1 presents a development of a paint spray gun generating a flat jet. The advantage of this development is that the flat jet can additionally be deflected perpendicularly to the spraying direction and perpendicularly to the extent of the flat jet by means of reducing valves provided in the air directors, the airflow through the air director being throttled on one side by means of a cross-sectional narrowing.

However, paint spray guns of this type have an increased susceptibility to faults, since the somewhat filigree orifices and the reducing valves to be produced by precision engineering may be conglutinated by paint particles, which unavoidably also accumulate in the air directors over time, and thus suffer an impairment of their functioning. Moreover, in HVLP appliances, the blower units generating an airflow are mostly set up with a view to a continuously uniform air delivery quantity, not least because this air delivery quantity has to be discharged for the purpose of cooling the blower as a consequence of its operation. A cross-sectional narrowing in the airflow to be specified therefore results in a variation in the dispensable air delivery quantity, thus, in turn, causing a back-up of air in the gun body.

### SUMMARY OF THE INVENTION

On the basis of the prior art, an object of the present invention, then, is to make available a paint spray gun with paint jet deflection which avoids the disadvantages of the prior art.

The paint spray gun according to the invention with paint jet deflection comprises a spray gun body with a paint reservoir, a paint dispensing device, an airflow gate with through flow orifices, an air cap with through flow orifices and a first through flow air director or air horn with a first air passage cross section and at least one second through flow air director or air horn with a second air passage cross section, the airflow gate being arranged in front of the air cap in the airflow direction in the region of the paint dispensing device. The invention is characterized in the present case in that the first air passage cross section is designed to be enlarged with respect to at least the second air passage cross section.

On the basis of the prior art, the paint dispensing device may be designed as a complete valve arrangement, but it may also comprise only a paint dispensing duct with a movable needle which then, in combination with the airflow gate, forms a needle valve arrangement. The airflow direction corresponds to the longitudinal axis of the upper gun body and essentially predetermines the outlet direction of the sprayed paint jet. The ratio of the air passage cross sections of the air directors with respect to one another affords the possibility of delivering different air quantities, since, in the case of a defined airflow inside the gun body and a defined internal pressure resulting from this, the free cross section of a passage area is decisive for the air quantity passing through.

In another embodiment of the paint spray gun, there is a provision whereby, in a first air director, the first air passage cross section is formed from a double duct system and, in a second air director, the second air passage cross section is formed from a single duct.

If the configuration of the guided airflow is as free of edges as possible, air guide ducts offer little resistance, and therefore turbulences and vortex formations are avoided in the airstream. Especially during the process of producing the air directors, air guide ducts can easily be implemented as an injection molding by means of manipulators or bores.

In another embodiment of the paint spray gun, there is provision whereby a prolonged longitudinal axis of the first air passage cross section together with a prolonged longitudinal axis of the second air passage cross section forms essentially an intersection point with a sprayed paint jet.

If the outlet direction of the airflows from the air directors is considered, the prolonged directional axes and the sprayed paint jet meet one another essentially at an intersection point. To generate a flat jet, the action of airflows upon the paint jet must be performed to the effect that at least one part component of the flow direction of a forming air jet does not run in the paint spraying direction. The paint jet thus undergoes a transverse force which influences the paint jet geometry, in particular generates a flat jet.

In another embodiment of the paint spray gun, a preferably centrically arranged paint passage orifice, in particular, in cooperation with a valve needle, as a paint metering device is provided in the airflow gate.

The airflow gate arranged at the front end of the gun body can act, via a centrically arranged paint passage orifice, as part of a paint metering device, in that a needle element, which is arranged in the gun body and can be moved via a regulating element, preferably a trigger guard on the handle of the spray gun, forms with the paint passage orifice a needle valve.

In another embodiment of the paint spray gun, the air cap is pierced preferably centrically by a paint metering device.

The paint metering device, which is preferably designed as a needle valve arrangement, may be formed either by the airflow gate or by differently designed constituents of the paint spray gun according to the invention. In order to avoid contamination in the region of the air paths during operation, it is advantageous no longer to lead the paint jet through constituents of the paint spray gun if possible after it has been generated due to the atomization of the metered paint by means of air flowing past, but, instead, for generating the paint jet, to lead the paint metering device through the air cap lying against the front end of the paint spray gun.

In another embodiment of the paint spray gun according to the invention, there is provision for designing the air directors as separate individual elements which can be fastened to the air cap, preferably can be plugged on.

By being designed as separate fastenable individual parts, the air directors can be produced substantially more simply, for example by the injection molding method. They may be produced as half shells foldable with respect to one another which form air directors and are connected by means of a film hinge and which, by being fastened to the air cap, are fixed with respect to one another at the fastening point.

In another embodiment of the paint spray gun, there is provision whereby the air cap is designed to be rotatable in relation to the airflow gate about the airflow direction or about a longitudinal axis of the gun body, and/or whereby the airflow gate is designed so that it can be plugged in the gun body, preferably using defined plug-in positions.

A rotatable position of the air cap in relation to the airflow gate makes it possible to implement different congruent positions of the two parts one above the other. In this case, different air guidance conditions can be achieved by means of different congruent positions of the respective air through flow orifices, this corresponding, for example, to a changeover between a radially symmetrical round jet and a flat jet.

However, one possible alternative to this possibility of varying the air guidance conditions to be achieved would also be to provide exchangeable air caps fixed in position for different air guidance conditions.

Additionally or alternatively to the rotatable position of the air cap in relation to the airflow gate, the airflow gate may also be designed to be removable from the gun body. A removable airflow gate can be inserted into the body again in a position rotated in relation to the gun body, so that the air through flow orifices of the airflow gate can also be arranged variably with respect to the gun body in order to achieve different air guidance conditions.

It is expedient to equip the gate and the body with mutually acting latching elements, so that the possible positions of the airflow gate are defined. Latching elements of this type may also be provided between the air cap and airflow gate.

A removable airflow gate which can be exchanged for other gates for different air guidance conditions may also be provided.

In a preferred embodiment of the airflow gate, the airflow gate comprises a paint passage orifice, at least one air passage orifice on a first radius about the paint passage orifice and at least one second air passage orifice on a second radius about the paint passage orifice.

The defined arrangement of the air passage orifices radially symmetrically about a paint passage orifice affords, for achieving defined air guidance conditions, a radially symmetrical symmetry system which comprises various defined states of congruence of the through flow orifices in the airflow gate and in the air cap.

In a further embodiment of the airflow gate, there is provision whereby at least one air passage orifice comprises both the first radius about the paint passage orifice and the second radius about the paint passage orifice.

An air passage orifice designed in this way in the airflow gate affords the possibility of making available an airflow of enlarged cross section which can be restricted in cross section solely by the air cap which follows in the flow direction. Basically, refinements may also be envisaged in which the enlarged air passage orifice is interrupted between the first radius and the second radius, for example, by a web, although the two orifices resulting from this are designed to be radially continuous in the same position.

In a further embodiment of the airflow gate, at least one forced ventilation orifice is provided between two operating air orifices on the first radius about the paint passage orifice, and at least one operating air orifice is provided between two forced ventilation orifices on the second radius.

Designated as an operating air orifice are those passage orifices which act actively upon the generated paint jet, on the one hand in order to generate a flat jet and, on the other hand, for oblique deflection out of the paint outlet direction in order to carry out oblique spraying.

Forced ventilation orifices make it possible for the blower to have a uniform air delivery quantity even when operating air orifices are completely or partially closed, so that damage to the blower, for example due to back-up and consequently reduced cooling, is avoided. The forced ventilation orifices do not or only insignificantly influence the paint jet, but ensure that regions ventilated thereby are kept free of impurities and paint deposits when the spray gun is operation.

In a further variant of the paint spray gun according to the invention, the airflow gate has an inner air through flow region about a preferably centric paint passage orifice.

A through flow region surrounding the paint passage orifice is necessary in order to form a defined symmetrical paint jet, since as uniform a laminar airflow as possible at the front paint outlet orifice has to entrain and atomize the emerging paint. Unevennesses or depressions in the surface of the airflow gate which improves the flow behavior of the airflowing past have proved to be advantageous in this case.

In another embodiment of the paint spray gun, the air cap has a centric through flow orifice.

In addition to the paint jet, the air quantity carrying the paint jet also has to be guided through the air cap. If the air cap is pierced by the paint metering device, the airflow forming the paint jet must be guided to the paint metering device. The air passage gap which forms between the centric through flow orifice of the air cap and the airflow gate is also designated as an annular gap.

In another embodiment of the paint spray gun, there is provision whereby the air cap has on a first radius at least one air passage orifice, preferably four air passage orifices arranged mirror-symmetrically in pairs.

Such air passage orifices are provided as air outlet orifices in order to ensure a uniform air delivery volume for round jet operation. On the rear side of the air cap, the air outlet orifices may be developed in such a way that they can communicate with an operating air orifice of the first or second radius.

In another embodiment of the paint spray gun, there is provision whereby the first air director and the second air director are arranged opposite one another, preferably radially symmetrically between further air passage orifices.

Air directors lying opposite one another can form the emerging paint jet into a flat jet either by acting upon it on both sides with airstreams, or, in the case of asymmetric operation, preferably one-sided operation, can provide a paint jet deflection out of the original paint jet direction into a direction angled with respect to this. The further air passage orifices constitute air outlet orifices for round jet operation or to avoid dirt deposits in the region of the air paths.

In another embodiment of the paint spray gun, at least one air passage orifice, preferably at least one air director, on the air cap is to be brought into congruence with at least one air passage orifice on a radius about the paint passage orifice on the airflow gate in such a way that a continuous air passage duct is obtained.

Air passage orifices arranged congruently with one another in this way afford a multiplicity of air guide combinations which are suitable for implementing the most diverse possible air guidance conditions, for example the generation of a round jet, of a horizontal flat jet, of a vertical flat jet and of oblique deflection to the side, upward or downward.

The basic idea according to the invention will be explained further in the following exemplary embodiments and illustrated by means of refinements.

However, the invention is not restricted to the exemplary embodiments shown, but embraces all those refinements which make use of the idea according to the invention.

### BRIEF DESCRIPTION OF THE DRAWINGS

FIG. 1 shows a spray gun fully assembled;

FIG. 2 shows a spray gun with an open body;

FIG. 3 shows examples of a spray gun in oblique spraying operation;

FIG. 4 shows an airflow gate in a front view;

FIG. 5 shows an airflow gate in a perspective view;

FIG. 6 shows an air cap in a front view; and

FIG. 7 shows an air cap in a perspective view.

### DETAILED DESCRIPTION OF THE INVENTION

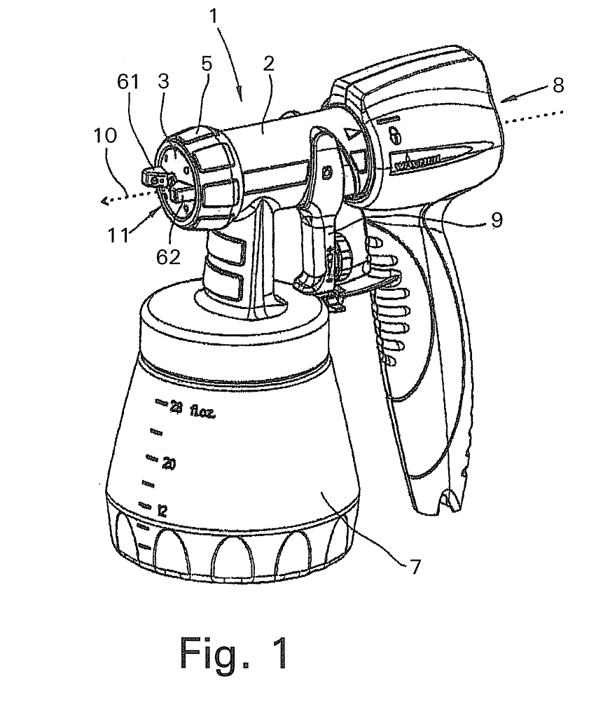

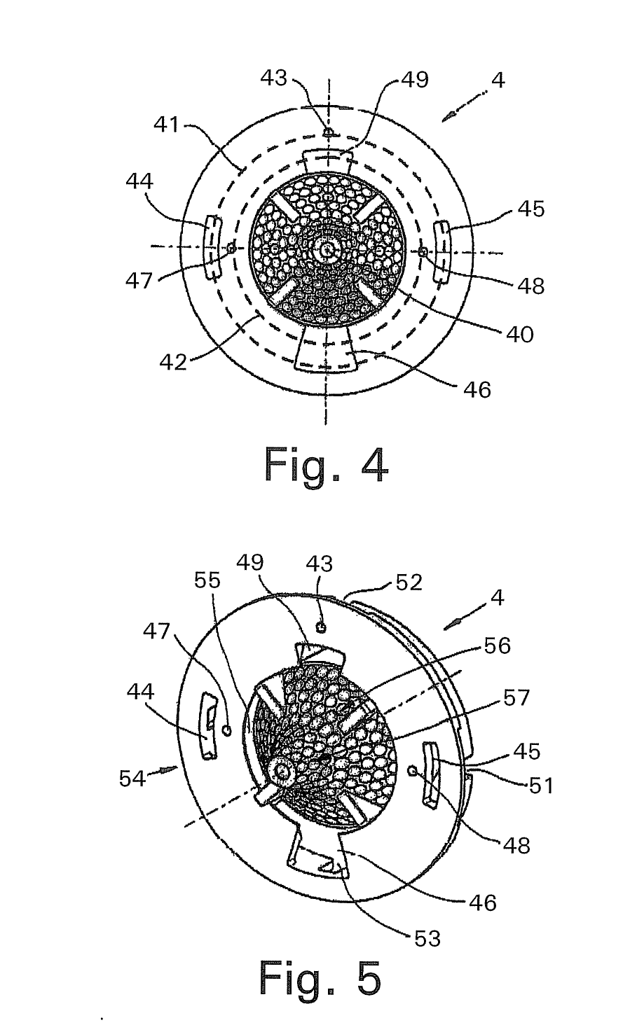

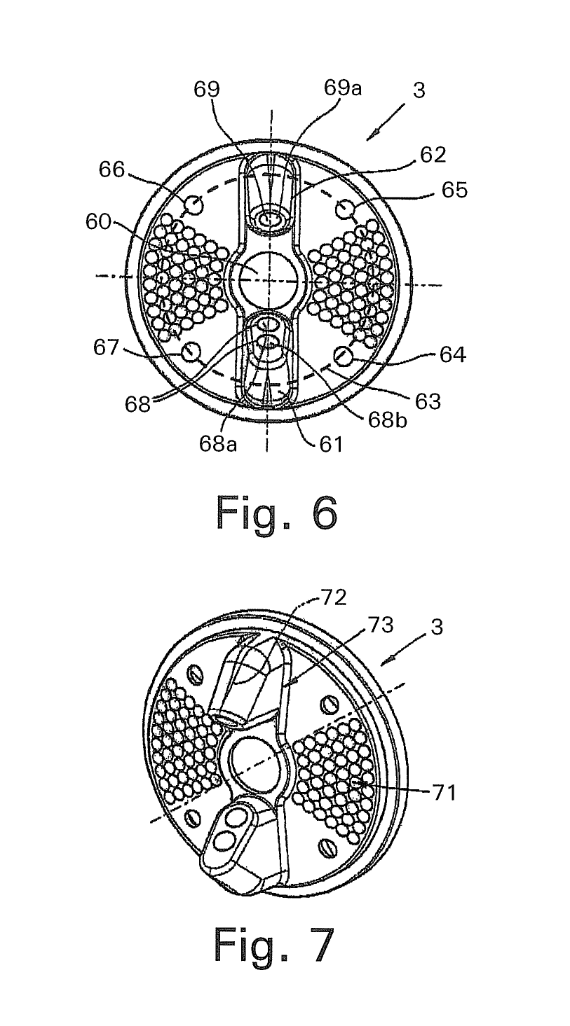

FIG. 1 shows a paint spray gun 1 constructed from a gun body 2, an air gate 4 (see FIG. 4) lying behind an air cap 3 and a union nut 5 securing the air cap on a thread 6. The paint spray gun 1 comprises, furthermore, a paint reservoir 7 and also an air supply connection 8 and a paint metering trigger 9. A first air director 61 and a second air director 62 in the form of air horns are arranged on the air cap 3 radially symmetrically with respect to the airflow direction 10 which in principle corresponds to the longitudinal axis of the gun body 2. The paint outlet orifice 11, designed in the present case in the form of a needle valve, is led through a central air passage orifice 60 in the air cap 3 (see FIG. 6), which air passage orifice forms an annular gap together with the air gate for the through flow of the air generating a paint jet. Further constituents which the paint spray gun comprises are not or are only insignificantly developed in the present case, and therefore there is no detailed description. Reference is made expressly to the knowledge arising from the prior art.

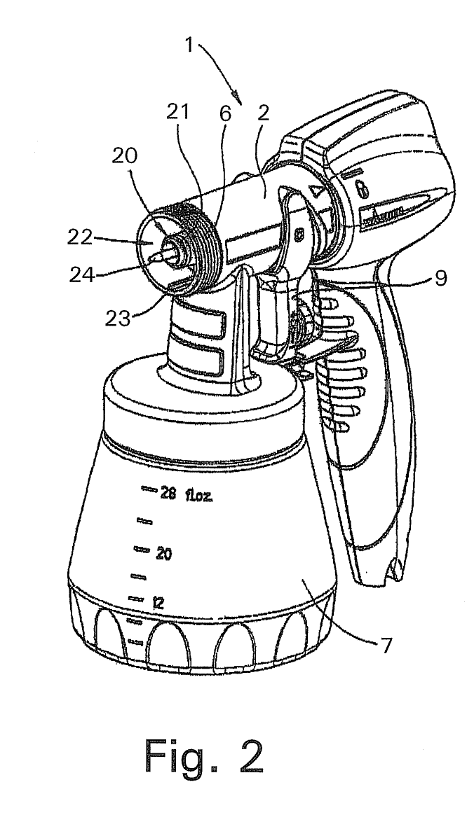

FIG. 2 shows a paint spray gun 1 with the union nut 5 removed, the air cap 3 removed and the air gate 4 removed. The paint dispensing device 20 is filled with paint from the reservoir 7 during operation and is sealed off by means of the air gate 4, via a sealing element 21, with respect to the airflow volume 22 in the gun body 2. A latching element 23 is provided at the lower region of the front orifice of the body 2 and makes it possible to have defined latching positions of the air gate to be inserted. The needle 24 is designed to be movable via the paint metering trigger 9 and, in cooperation with the paint passage orifice 40 of the air gate 4 (see FIG. 4), provides a paint metering device in the form of a needle valve.

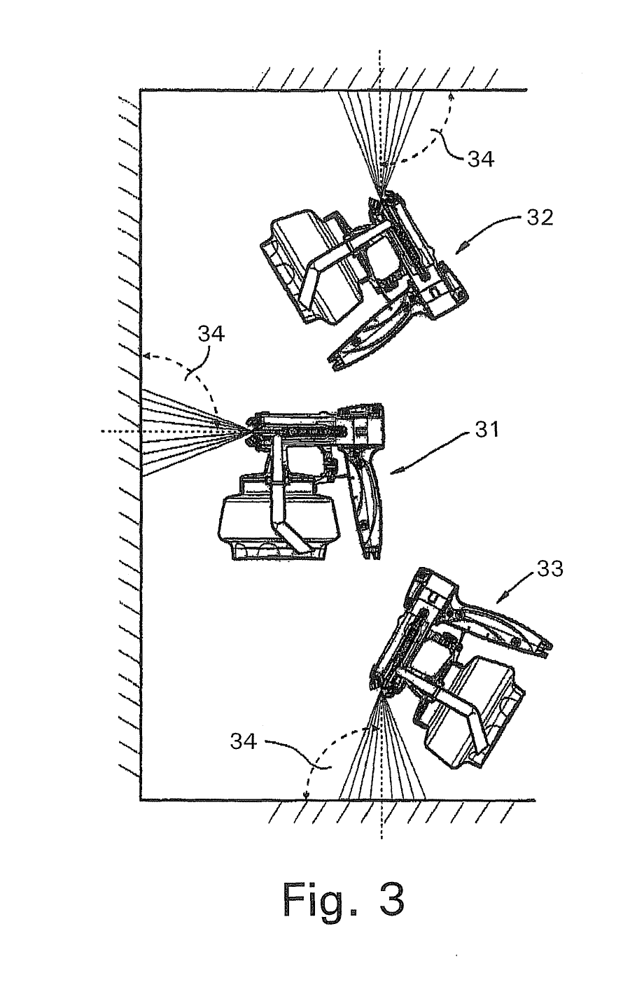

FIG. 3 shows various applications of a paint spray gun 1 according to the invention with paint jet deflection. Without the paint jet deflection being activated, operation may take place, for example, with a round paint jet or with a horizontal or vertical flat jet, as illustrated at 31.

In order to treat ceiling surfaces, it is advantageous if the gun does not have to be tilted through 90 degrees, since the paint is thereby prevented from running back out of the paint reservoir into the fastening region of the paint reservoir. In addition, the handling of a paint spray gun, especially when lengthy work is being carried out, is improved considerably if a posture approximate to the natural hand posture can be assumed. Since an impingement angle 34 of the paint jet on the surface of 90 degrees is always desirable for a successful and high-quality paint coating of a surface, an improved handling of the spray gun can be ensured ensuring upward oblique spraying 32 as a result of the paint jet deflection.

By the arrangement of the air passage cross sections of the air former being adjusted into the opposite direction, downward oblique spraying 33 can also be implemented.

The various possibilities for setting the operating modes of a paint spray gun according to the invention will be described below by means of the functional description of the individual through flow orifices in the airflow gate 4 and air cap 3.

FIGS. 4 and 5 show that airflow gate 4 has an outer first radius 41 and an inner second radius 42 about the center of its paint passage orifice 40. Air outlet orifices are arranged on the first gate radius 41 radially symmetrically and in each case at an interval of one quarter of a revolution and differ from one another in the available cross sections. The small forced ventilation orifice 43 is surrounded on both sides by two operating air orifices 44, 45 and, opposite, has a further-enlarged operating air orifice 46.

The enlarged operating air orifice 46 is likewise located on an inner second gate radius 42 and surrounded by two forced ventilation orifices 47, 48 and lies opposite an inner operating air orifice 49.

The perspective view of the airflow gate 4, as illustrated in FIG. 5, shows the grooves 51, 52, 53, 54 which are provided for cooperation with the latching element 23 and which provide defined positions of the air gate 4 in the gun body 2. The radially symmetrical inner air through flow region 55 serves the generation of paint jet from the paint emerging out of the paint passage orifice 40. The region lying within the inner radius 42 is provided at least partially with depressions 56 which afford an improved airflow behavior.

FIG. 6 shows an air cap 3 in the front view with a first air director 61 and with a second air director 62. The central passage orifice 60 forms together with the cone 57 (see FIG. 5), piercing this, of the air gate 4 an annular gap which lies between them and which is conducive to the formation of an optimal paint jet.

Air outlet orifices 64, 65, 66, 67 are arranged on a cap radius 63 surrounding the central orifice 60 and allow a controlled dispensing of air in round jet operation.

The first air director 61 has a first air passage cross section 68 which is formed by an inner air duct 68a and an outer air duct 68b.

The second air director 62 has only one air duct 69a as a second cross section 69.

FIG. 7 illustrates a perspective illustration of the air cap 3 according to the invention which likewise has on parts of the surface depressions 71 for an improved airflow.

The air directors may either be produced in one piece with the air cap 3, for example by the injection molding method, or be produced in a simplified way as separate parts, for example as half-shaped folding parts. The halves thus produced could be fixed, folded, in the region 72 via a film hinge connection and be introduced in a fastening region 73, for example, into a dovetail structure or another kind of back-fitting joining structure, with the result that a fixed connection to the air cap 3 is made.

To achieve various air guidance conditions, then, the air cap 3 and the air gate 4 are positioned with respect to one another in such a way that a specific combination of operating orifices 44, 45, 46, 49 meet a specific combination of air outlet orifices 64, 65, 66, 67 or air ducts 68a, 68b, 69a. Operation with upward paint jet deflection may be described as an example of this.

The orifice 46 illustrated in FIG. 4 meets both ducts 68a and 68b in the specified position. The duct 69a ending on the inside of the radius 63, this corresponding to the position on the radius 41 of the air cap and therefore of the forced ventilation orifice 43, is supplied with only a very small air quantity which prevents paint particles from being deposited in the duct 69a. The orifices 64, 65, 66, 67 of the air cap 3 are inoperative in this position. Thus, the emerging paint jet is deflected upward by the air quantity emerging from the first air director 61 through its first cross section 68, this corresponding to the operating mode 32 from FIG. 3. If, then, the air cap 3 is rotated through 180 degrees in relation to the gate 4, the orifice 49 meets the duct 68a, the duct 68b receiving only forced ventilation through the orifice 43. The duct 69a in this case lies above the enlarged orifice 46 and therefore receives the air quantity corresponding to its cross section 69. As a result of this setting, a paint jet which is not deflected but is in the form of a horizontal flat jet is obtained.

By means of appropriate variations in the position of the air gate 4 and of the air cap 3 with respect to the gun body 2, the further operating modes referred to can be implemented. If the orifices 64, 65, 66, 67 are brought into congruence with the operating air orifices 44, 45, 46, 49, a round jet is formed.

### LIST OF REFERENCE SYMBOLS

1 Paint spray gun
2 Gun body
3 Air cap
4 Air gate
5 Union nut
6 Thread
7 Ink reservoir
8 Air supply connection
9 Paint metering trigger
10 Airflow direction
11 Paint outlet orifice
20 Paint dispensing device
21 Sealing element
22 Airflow volume
23 Latching element
24 Needle
31 Normal operation
32 Upward oblique spraying
33 Downward oblique spraying
34 Impingement angle
40 Paint passage orifice
41 First gate radius
42 Second gate radius
43 Forced ventilation orifice
44,45 Operating air orifices
46 Enlarged operating air orifice
47,48 Forced ventilation orifices
49 Inner operating air orifice
51,52,53,54 Grooves
55 Inner air through flow region
56 Depressions
57 Cone
60 Central air passage orifice
61 First air director
62 Second air director
63 Cap radius
64,65,66,67 Air outlet orifices
68 First air passage cross section
68a Inner air duct
68b Outer air duct
69 Second air passage cross section
69a Air duct
71 Depressions
72 Film hinge region
73 Fastening region

1. A paint spray gun with paint jet deflection, comprising a spray gun body with a paint reservoir, a paint dispensing device, an airflow gate with through flow orifices, an air cap with through flow orifices, a first through flow air director with a first air passage cross section and at least one second through flow air director with a second air passage cross section, the airflow gate being arranged in front of the air cap in the airflow direction in the region of the paint dispensing device, wherein the first air passage cross section is larger than the second air passage cross section.

2. A paint spray gun according to claim 1, wherein in the first air director, the first air passage cross section is formed from a double duct system and, in the second air director, the second air passage cross section is formed from a single duct.

3. A paint spray gun according to claim 1, wherein a prolonged longitudinal axis of the first air passage cross section together with a prolonged longitudinal axis of the second air passage cross section form an intersection point with the longitudinal axis of a sprayed paint jet.

4. A paint spray gun according to claim 1, wherein the airflow gate has a centrically arranged paint passage orifice that cooperates with a valve needle as a paint metering device.

5. A paint spray gun according to claim 1, wherein the air cap is pierced centrically by a paint metering device.

6. A paint spray gun according to claim 1, wherein the air directors are designed as separate individual elements which are fastened to the air cap.

7. A paint spray gun according to claim 6, wherein the air directors are plugged in the air cap.

8. A paint spray gun according to claim 1, wherein the air cap is rotatable in relation to the airflow gate about one of the airflow direction and a longitudinal axis of the gun body.

9. A paint spray gun according to claim 8, wherein the airflow gate is plugged in the gun body using defined plug-in positions.

10. A paint spray gun according to claim 1, wherein the airflow gate has a paint passage orifice, at least one air passage orifice on a first radius about the paint passage orifice and at least one second air passage orifice on a second radius about the paint passage orifice.

11. A paint spray gun according to claim 10, wherein at least one air passage orifice encompasses both the first radius about the paint passage orifice and the second radius about the paint passage orifice.

12. A paint spray gun according to claim 10, further comprising at least one forced ventilation orifice between two operating air orifices on the first radius about the paint passage orifice, and at least one operating air orifice is provided between two forced ventilation orifices on the second radius.

13. A paint spray gun according to claim 1, wherein the airflow gate has an inner air through flow region about a centric paint passage orifice.

14. A paint spray gun according to claim 1, wherein the air cap has a centric through flow orifice.

15. A paint spray gun according to claim 1, wherein the air cap has at least one air passage orifice on a first radius.

16. A paint spray gun according to claim 15, wherein the air cap has four air passage orifices arranged mirror-symmetrically in pairs.

17. A paint spray gun according to claim 1, wherein the first air director and the second air director are arranged opposite one another.

18. A paint spray gun according to claim 17, wherein the first air director and the second air director are arrange radially symmetrically between additional air passage orifices.

19. A paint spray gun according to claim 1, wherein at least one air passage orifice on the air cap is brought into congruence with at least one air passage orifice on a radius about the paint passage orifice on the airflow gate such that a continuous air passage duct is gate such that a continuous air passage duct is obtained.

20. A paint spray gun according to claim 1, wherein at least one air director on the air cap is brought into congruence with at least one air passage orifice on a radius about the paint passage orifice on the airflow gate such that a continuous air passage duct is obtained.
